(19) United States
(12) Patent Application Publication
(10) Pub. No.: US 2008/0034671 A1
(43) Pub. Date: Feb. 14, 2008

(54) SYSTEM AND APPARATUS FOR SHIELDING PROPERTY

(76) Inventor: Patrick Harrington, Massapequa, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/832,463

(22) Filed: Aug. 1, 2007

Related U.S. Application Data
(60) Provisional application No. 60/837,445, filed on Aug. 14, 2006.
(60) Provisional application No. 60/893,201, filed on Mar. 6, 2007.

(51) Int. Cl. E06B 9/00

(52) U.S. Cl. 52/2.26; 52/2.25; 52/745.15

(57) ABSTRACT

A temporary protective system provides for minimizing storm damage to selected framing systems of a structure, such as door or window openings, while also eliminating the permanent installation damage common to such structures when conventional plywood covers, shutters, or metal shielding are installed. The protective system incorporates an inflation involved system and an attachment or securing system for securing the inflation system relative to the selected framing or structural system without damage. The multiple proposed systems allow a user to install each protective system from a convenient position and to uninstall the system without causing structural damage for later compact storage. An additional rigid shielding member, or a series of rigid shielding members, may be incorporated to provide additional protection.

### CROSS REFERENCE TO RELATED APPLICATIONS

This application claims priority from U.S. Provisional App. Ser. No. 60/837,445 filed Aug. 14, 2006, and U.S. Provisional App. Ser. No. 60/893,201 filed Mar. 6, 2007, the entire contents of each of which are herein fully incorporated by reference.

### FIGURE SELECTED FOR PUBLICATION

FIG. 1g

### BACKGROUND OF THE INVENTION

1. Field of the Invention

The present invention relates to a system, apparatus, and kit for shielding property. More specifically, the present invention relates to a system enabling property owners in the path of a storm to minimize property damage via windows and access ways in both a reasonably expeditious manner and at a reasonable cost.

2. Description of the Related Art

The related art involves various method, systems, and forms of property protection in the face of approaching inclement weather (for example hurricanes, hail storms, tornadoes, and other weather phenomena, e.g., generally storms).

It is recognized by those of skill in the art that the windows, doors, and access-ways of a structure are often the most vulnerable to storm damage. This vulnerability is typified by the existence of glass, translucent, transparent, or decorative coverings, and pivotable hinges (doors) that allow a ready pathway into a structure, and thereupon structural failure. Conventionally these vulnerable points do not have a structural strength comparable to a surrounding wall or frame. As a consequence, these vulnerable points are recognized as potential access points into the structure for storm debris such as wind-born material and any accompanying water (rain, hail, snow, storm surge, sea flood, etc.).

Conventional techniques for protecting glass or access ways (doors) include the use of pivitably fixed shutters, the attachment of fixed shutters, panels, or boards (plywood) secured to a surrounding frame, sand-bagging (stacking sand bags to a height sufficient to cover the opening/window), the application of reinforcing flexible tape to a glass surface, and the use of tempered glass in a toughened frame structure, each providing a generally non-removable/difficult to remove and non-reusable protection to a structure.

Unfortunately, what is not appreciated by the above-noted related are the limitations existent within the population itself due to age, infirmity, and lack of carpentry skill; as well as the attendant costs of taking such protective steps. These detrimental costs include, for example, the cost of purchasing for a single-use, sheets of plywood and hiring installers to affix the sheets in place and to remove such sheets after passage of the storm. Similarly, what is also not appreciated is the attendant cost for such protection, wherein the protection may be needed multiple times over a period of years, greatly enhancing costs.

One particular grievance now recognized within the aged population of the southern states is the physical stress of taking these protective steps. For example, an aged user may be physically incapable of lifting a heavy panel of plywood, may not be able to manipulate removable rigid shutters, and may be physically unable to climb a ladder to affix such shutters or panels. As a consequence therefore, what is not appreciated by the conventional arts is the need for a simplified system, kit, or apparatus that may be readily engaged to protect a window or access point from storm damage, that leaves no detrimental post-use removal damage, and that may be readily disengaged (temporary use) following use by a user of limited physicality and limited physical dexterity.

Accordingly, there is a need for an improved temporary protective system for structurally vulnerable windows, doors, and other structural access points that may be readily manipulated by the consuming public, and acquired at a reasonable cost.

### OBJECTS AND SUMMARY OF THE INVENTION

An object of the present invention is to provide a temporary inflatable protective system for a structural system that address at least one of the needs noted above.

Another object of the present invention is to provide an inflatable protective system that is readily removable and storable post-use while allowing rapid and non-damaging installation.

The present invention relates to a temporary protective system that provides for minimizing storm damage to selected framing systems of a structure, such as door or window openings, while also eliminating the permanent installation damage common to such structures when conventional plywood covers, shutters, or metal shielding are installed. The protective system incorporates an inflation system and an attachment or securing system for securing the inflation system relative to the selected framing or structural system without damage. The proposed systems allow a user to install each protective system from a convenient position and to uninstall the system without causing structural damage for later compact storage. An additional rigid shielding member, or a series of rigid shielding members, may be incorporated to provide additional protection.

According to an embodiment of the present invention there is provided a protective system, for providing a temporary-use protection to a framing system of a structure, comprising: an inflation system, and an attachment system for removably securing the inflation system to the framing system, whereby the inflation system may be deflated and removed following the temporary-use protection.

According to another embodiment of the present invention there is provided a protective system, further comprising: at least one of a strap member and an adhesion member in the attachment system.

According to another embodiment of the present invention there is provided a protective system, wherein: the attachment system includes at least the strap member, and the at least one strap member including at least one buckle member for securing the strap member relative to the framing system.

According to another embodiment of the present invention there is provided a protective system, wherein: the attachment system includes the adhesion member, and the adhesion member is at least one of a suction-cup member, a Velcro member, and a chemical adhesive member, whereby the attachment system may be removably secured to a the framing system.

According to another embodiment of the present invention there is provided a protective system, wherein: the inflation system includes at least one of means for inflation prior to the temporary-use and means for deflation of the inflation system following the temporary-use.

According to another embodiment of the present invention there is provided a protective system, further comprising: at least one of a flexible strengthening layer and a rigid shielding system on an external surface of the inflation system, whereby the at least one provides an enhanced protection to the framing system.

According to another embodiment of the present invention there is provided a protective system, further comprising: at least one non-inflatable fixably removable shield member, wherein the protective system may be readily adapted to alternative framing systems of a structure.

According to another embodiment of the present invention there is provided a protective kit, for providing temporary protection to a framing system of a structure comprising: inflatable means for providing a temporary barrier to the framing system, and attachment means for removably securing the inflatable means for providing relative to the framing system.

According to another embodiment of the present invention there is provided a protective kit, further comprising: a decorative outer covering to the inflatable means for providing, whereby the protective kit is readily adapted to a decorative display.

According to another embodiment of the present invention there is provided a method for manufacturing a temporary protective system for a framing system, comprising the steps of: measuring a dimensional system for a framing system requiring the temporary protective system, providing an inflatable means for providing a temporary barrier to the framing system, and providing at least one attachment means for removably securing the inflatable means to the framing system, whereby the temporary protective system is manufactured.

The above, and other objects, features and advantages of the present invention will become apparent from the following description read in conduction with the accompanying drawings, in which like reference numerals designate the same elements.

### BRIEF DESCRIPTION OF THE DRAWINGS

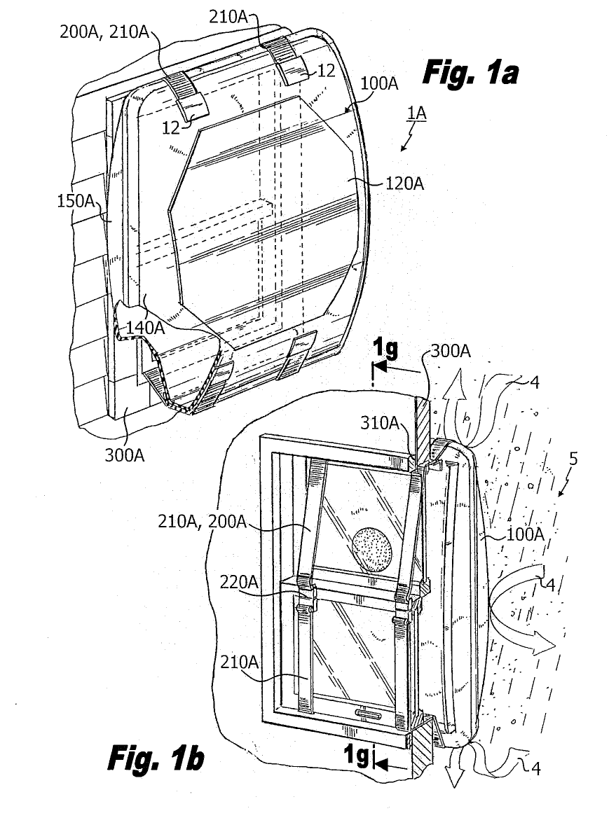

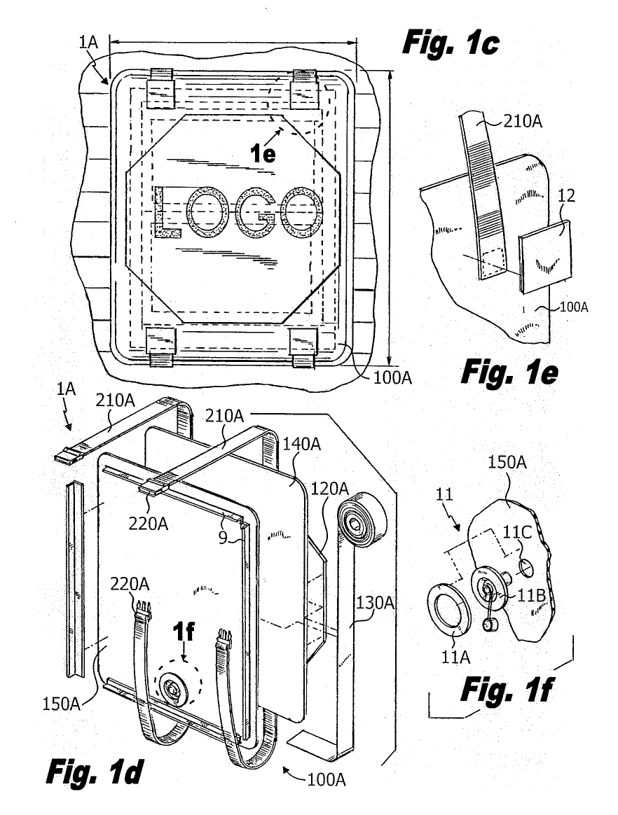

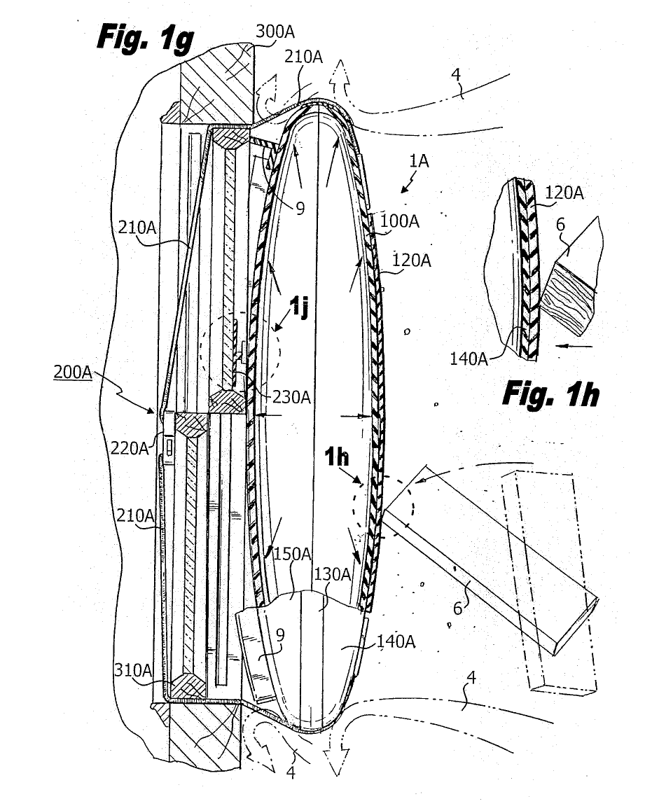

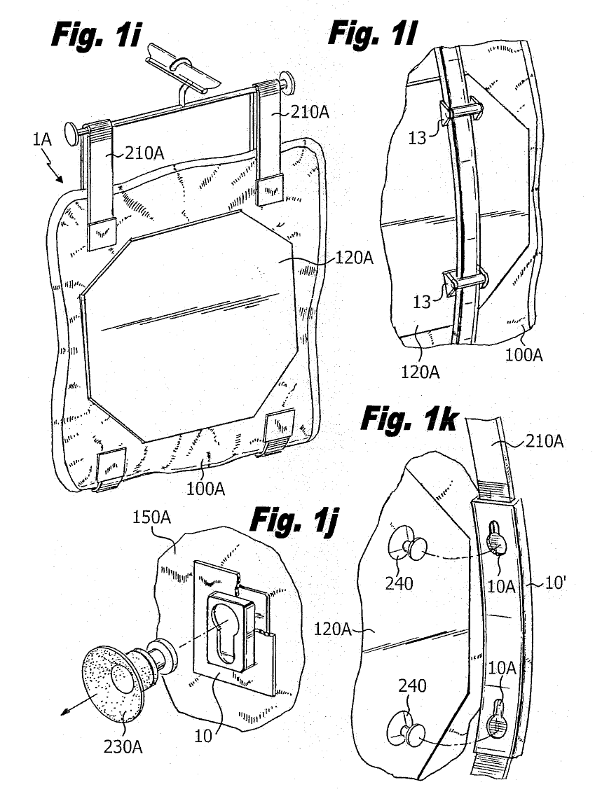

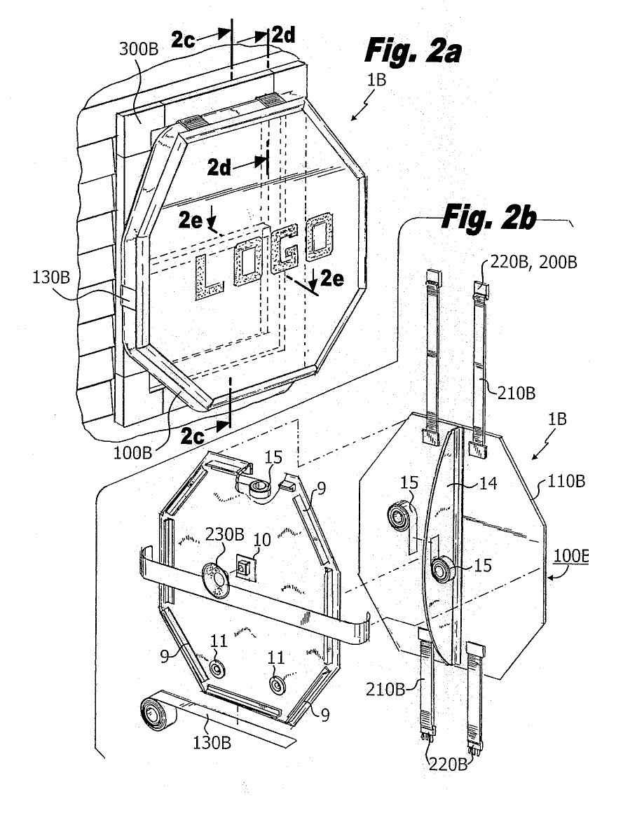

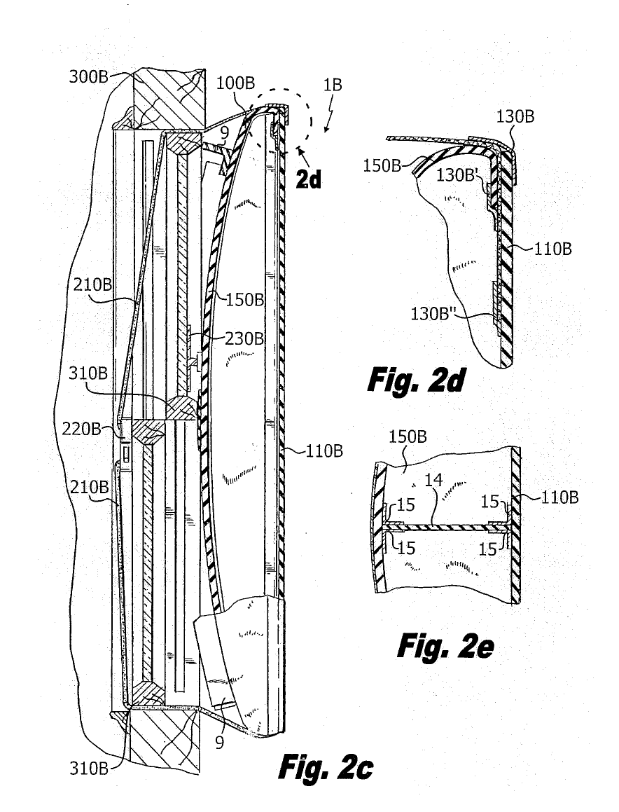

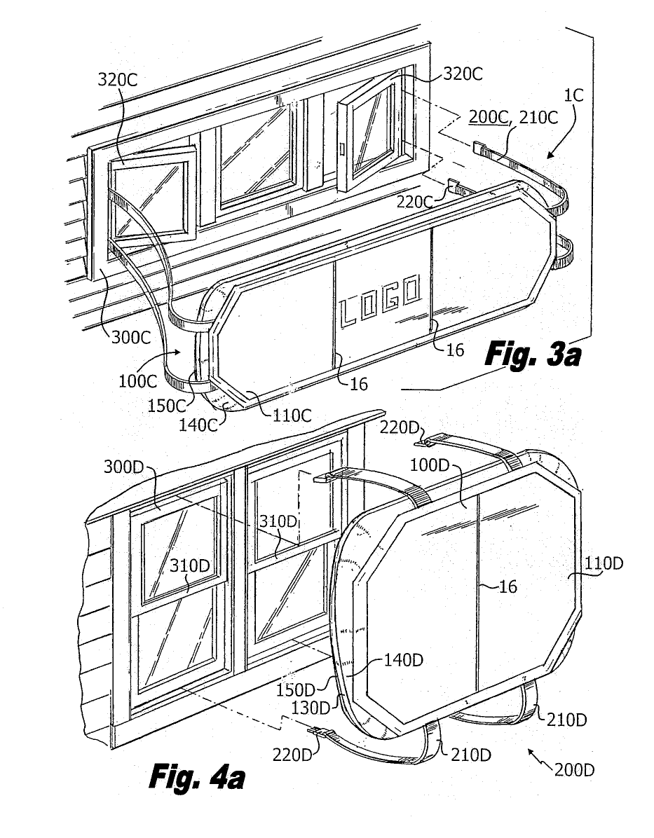

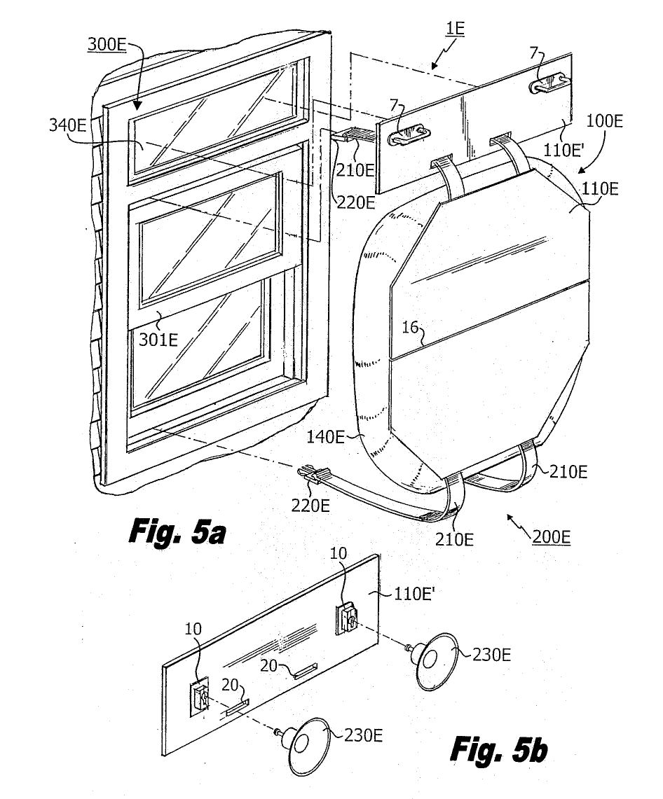

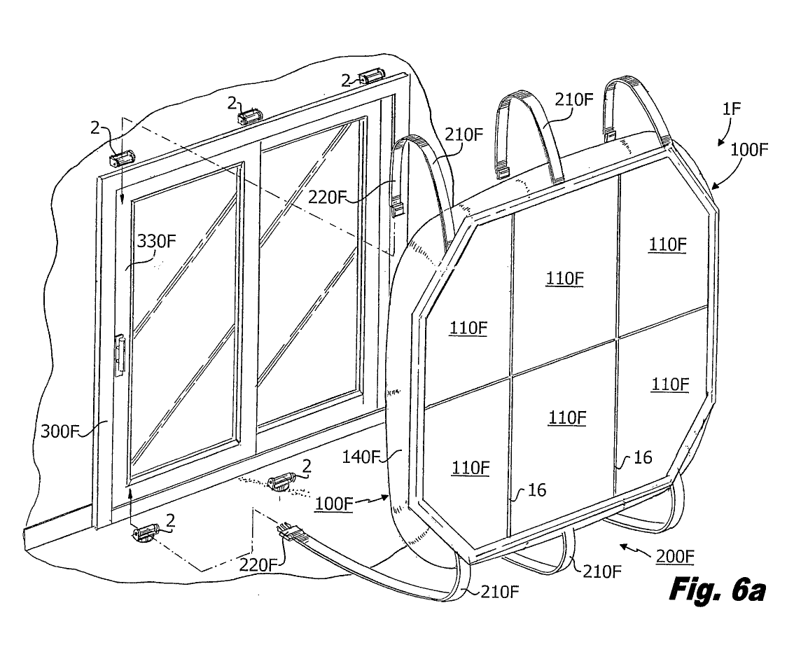

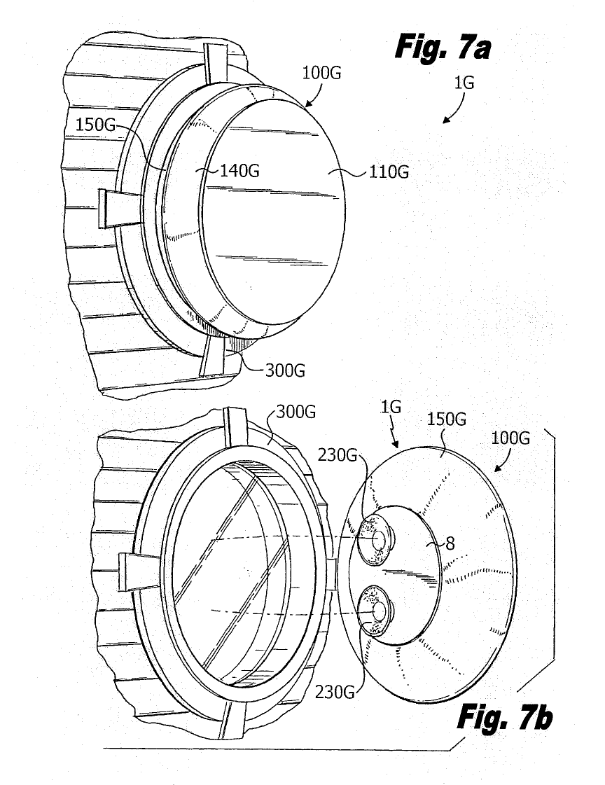

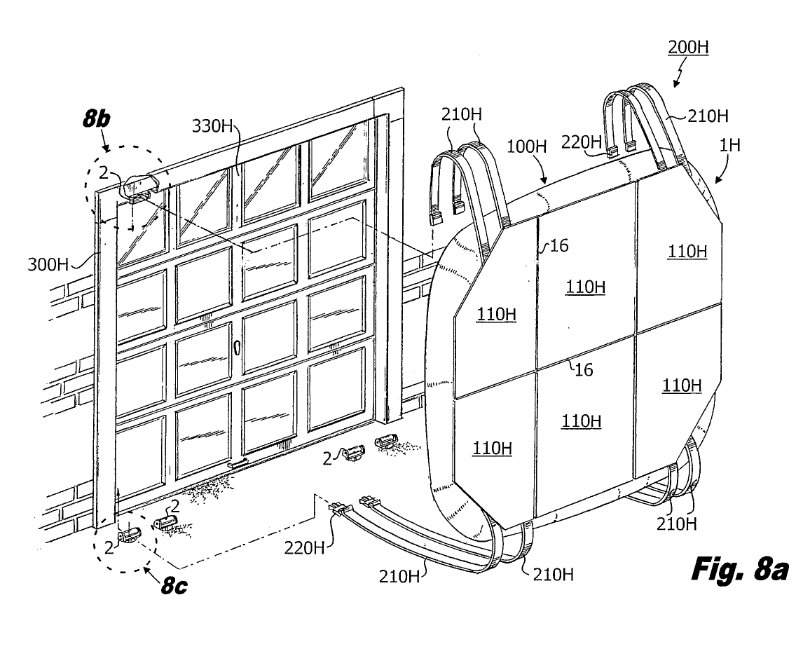

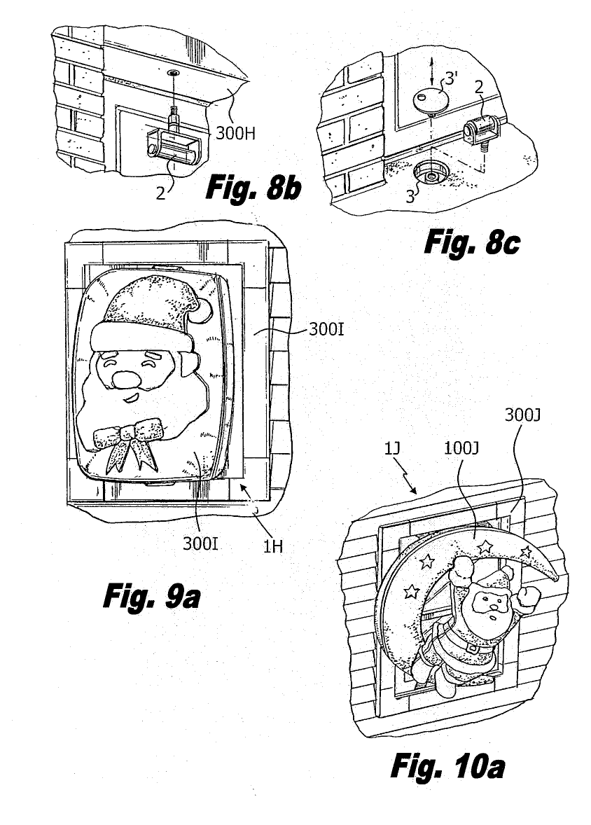

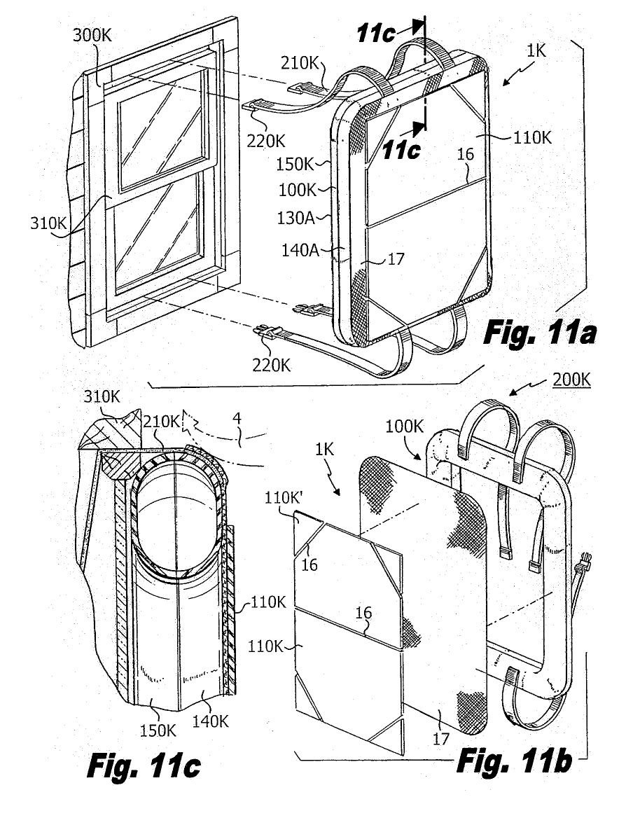

FIG. 1a. is a partially cut-away inflated perspective view of a first shielding system embodiment of the present invention.

FIG. 1b is a partial sectional view of the reverse side of FIG. 1a along a structural cut line through the window structure, noting the double-hung window construction.

FIG. 1c is a front view of the embodiment in FIG. 1a with an attendant logo patch.

FIG. 1d is an exploded construction view of the inflatable first embodiment noted in FIG. 1a.

FIG. 1e is a partial sectional view from section 1e in FIG. 1c.

FIG. 1f is a partial exploded view of the inflation valve member noted at section 1f in FIG. 1d.

FIG. 1g is a sectional view along line 1g-1g of the inflated protective device as noted in FIG. 1a undergoing a debris impact.

FIG. 1h is a partial view of section 1h in FIG. 1h highlighting the debris impact on the layered outer protective surface of the inflated member.

FIG. 1i depicts a perspective inflated view of the first embodiment in FIG. 1a as stored in a deflated non-use condition on a hanger in a closet for convenience.

FIG. 1j is a perspective and partial sectional view of an optional attachment system.

FIG. 1k is another perspective exploded view of an optional attachment system involving a strap member and affixing points.

FIG. 1l is another perspective view of an optional attachment system noting a slidable and adjustable connection between a strengthening layer and a strap member.

FIG. 2a is perspective inflated view of another shielding system according to the present invention.

FIG. 2b is a partially exploded view of the alternative shielding system noted in FIG. 2a.

FIG. 2c is a partially cut away and cross-sectional view of the second shielding system noted along line 2c-2c in FIG. 2a.

FIG. 2d is a partial cross-sectional view along line 2d-2d in FIG. 2a noting an optional feature of an attachment system.

FIG. 2e is a partial cross-sectional view along line 2e-2e in FIG. 2a, noting an inner strengthening baffle.

FIG. 3a is an inflated perspective view of another alternative shielding system according to the present invention.

FIG. 4a is an inflated perspective view of another alternative shielding system according to the present invention.

FIG. 5a is an inflated perspective view of another alternative shielding system according to the present invention.

FIG. 5b is a perspective back view of a rigid panel member as seen in FIG. 5a.

FIG. 6a is an exploded perspective view of another alternative inflatable shielding system according to the present invention.

FIG. 7a is a perspective view of another alternative inflatable shielding system according to the present invention for use is non-opening windows, or those having unusual dimensions.

FIG. 7b is a partially exploded perspective view of the inflatable shielding system relative to a window opening requiring protection according to the present invention noting an alternative attachment system.

FIG. 8a is a partially exploded perspective view of another alternative inflatable shielding system according to the present invention for use with larger areas requiring protection, for example garage doors.

FIG. 8b is a partial perspective close view of section 8b in FIG. 8a.

FIG. 8c is a partial perspective close view of section 8c in FIG. 8a.

FIG. 9a is a perspective view of another alternative inflatable shielding system according to the present invention enabling a double use with a decorative function.

FIG. 10a is a perspective view of another alternative inflatable shielding system according to the present invention enabling an additional decorative function where the decorative feature serves as the inflation system.

FIG. 11a is an exploded perspective view of another alternative inflatable shielding system according to the present invention wherein an outer inflatable portion supports a rigid support system (formed from single or multiple rigid members alternatively interlinked).

FIG. 11b is an exploded view of the shielding system noted in FIG. 11a.

FIG. 11c is a sectional view along line 11c-11c in FIG. 11a.

### DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” “inflate”, “attach” and similar terms with their inflectional morphemes do not necessarily denote direct and immediate connections, but also include connections through mediate elements or devices.

Referring now generally to FIGS. 1a-1l, a first exemplary protective system embodiment 1A is noted. Protective system 1A includes, as will be discussed more broadly below, an inflation system 100A for enabling a protection of an external structural system 300A from the impact of debris 6, rain 5, or high energy wind 4, and an attachment or securing system 200A for securely positioning the inflation system 100A in a preferred location relative to structural system 300A.

As noted in FIGS. 1a-1l, the particular structural system 300A requiring protection is exemplified by a conventional double hung window framing system 310A, although the present invention shall not be so limited, and may be readily adapted to casement, pivot, swing, and other types of residential and commercial window frames and window types all without departing from the scope and spirit of the present invention.

It is envisioned that the proposed protective systems may be readily adapted to a wide variety of structural systems requiring protection from storm debris, and that these structural systems will readily include double hung systems such as 310A, a casement window type system 320A (as will be discussed), a sliding door 330A, a garage door, specialty windows, shop doors, or other openings within the framing of a conventional structure (all as will be further discussed below). Those of skill in the art shall recognize that the present invention is not limited to providing protection to those structural systems noted herein, and shall recognize that the proposed inventive system may be readily adapted to a wide variety of protective needs available from a survey of conventional framing, building, and structural systems, each having respective regions of lowered durability to storm debris, and hence requiring assistive protection there from.

The initial exemplary embodiment noted in FIGS. 1a-1l is reflective of a framing system 300A widely available, and also one in which the aged and infirm are familiar. A particular benefit of the presently proposed protective systems is their ready installation by persons who are aged, infirm, or less dexterous then a conventional window installer may be. Consequently, the presently proposed protective systems fulfill a unique niche in commerce allowing users a convenient, lower risk, reduced effort installation and removal. As an additional consequence of the benefits provided by the proposed system, it is suggested that a greater number of citizens will rapidly and readily prepare their structures in the face of an approaching storm and so increase the overall population of protected structures lowering storm damage generally and resulting ultimately in lowered structural insurance costs.

As noted herein, inflation system 100A may be formed variously without departing from the scope and spirit of the present invention, but as shown includes a front or first side layer 140A and a rear or second layer 150A, joined about an outer perimeter, and including an additional side strap sealing member 130A offering additional structural integrity under high pressure inflation.

While it is recognized that front and rear layers 140A, 150A, and where existing an additional side strap layer 130A may be constructed from any suitable material to accomplish the requirements herein, including for example PVC (polyvinyl chloride), ethylene dichloride (EDC) monomers, vinyl chloride monomers (VCM)) Mylar, plastic, neoprene, plastic composite, woven materials (such as nylon and impregnated nylon etc.), any related thermoplastic material, any manmade or natural fiber textile, and composites and multi-layers of the same (for example a PVC-woven nylon).

While the present embodiment is preferably made from PVC because it offers excellent strength, puncture resistance, corrosion, and weather resistance this invention is not limited thereto. It is also recognized that PVC has a high strength-to-weight ratio and is a good electrical and thermal insulator which may be beneficial during a storm condition. Similarly, PVC is readily used in inflatable boat construction, and so the construction techniques and assembly techniques known therein have been developed for boat use.

It shall also be recognized that nothing herein shall restrict the selection of flexible inflation members to opaque materials. Consequently, inflation system 100A may be constructed from translucent, transparent, or opaque materials without departing from the scope herein. Thus, a user may select a transparent material so as to allow some light to enter the structure with protective system 1A in position.

As a consequence of the above, it shall be recognized that an optional strengthening layer 120A of PCC or other suitable material may be attached to front or first layer 140A to provide additional impact resistance. As will be noted particularly in FIG. 1h, flexible strengthening layer 120A may include a logo for aiding rescue (see FIG. 1c) and operates in the present embodiment as a shear layer upon front layer 140A, acting to distribute the impact force via shear movement from debris 6 mitigating damage to front layer 140A. It shall also be recognized that strengthening layer 120A may be adhered or joined to front layer 140A for additional strength.

An inflation valve system 11 (see FIG. 1f) is provided on rear layer 150A and includes an opening 11C, filled with an inflation valve 11B, and a sealing ring 11A securely joining an outer perimeter of inflation valve 11B to rear layer 150A. Those of skill in the art will recognize that there is a plurality of conventional inflation valving systems that may be readily substituted for inflation valve system 11 without departing from the spirit and scope of the present invention. Those of skill in the art will also recognize that inflation valving system 11 may be readily adapted to exist in each inflation or protection system noted herein, and may optionally, and in some constructions preferably, include a long extension nozzle so that a user may continue to inflate an inflation system from a distant or convenient position. For example, a long extension nozzle may extend for many inches or even many feet so that a user may provide inflation pressure with a window partially closed or from a separate location outside a structure.

Attachment system 200A may take many forms sufficient to securely position inflation system 100A relative to structural system 300A, and as shown includes a plurality of strapping members 210A, fixed to front layer 140A via sewing (FIG. 1e), and extending from reinforcing members 12. It shall be recognized that strapping members 210A are not limited to the simple straps as shown but shall also include ready adjustment and position locking systems as well known in the web-strapping arts for recreation, sports, and law enforcement.

Respective buckle members 220A are positioned at ends of strapping members 210A and engage respective buckle members 210A extending from sister strapping members so as to securely fix protective system 1A relative to structural system 300A. Buckle members 220A may be adjusted along the length of strap members 210A for optimal positioning.

As shown in FIGS. 1a-1l, strap and buckle members 210A, 220A pass through a top and bottom open-window portion of double hung window system 310A. As a consequence, a user may readily position protective system 1A from the inside of their structure in a convenient position. Upon initial positioning, respective windows in double hung system 310A are positioned in close association for maximum maneuverability.

Thereafter (or prior to initial installation or even after final installation), a user inflates inflation system 100A by pressurizing the same via valve 11 and sealing the same. Next, with the inflation member 110A positioned external to structural system 300A (a window), the windows are closed and locked in position. It will be recognized that the weather-flanges or weather-stripping common in many windows is readily deflected and are sufficiently flexible to allow a user to tension strap members 210A to remove slackness and enhance security without damaging the window or compromising a final position and while retaining substantial weather integrity.

Those of skill in the art will also recognize that noting of the assembly process or installation process discussed herein shall be limiting to the invention, and as such the present discussion recognizes that the same or similar systems may be installed in differing ways without departing the scope herein. For example, inflation system may be installed and secured via strap members 210A in a non-inflated member, and then inflation system 100A inflated, providing additional securing tension to strap members 210A, without departing from the scope of the present invention.

As a consequence, and referring specifically now to FIGS. 1g and 1j. an alternative positioning member 230A (shown here as a suction cup) may be installed on an exterior window surface, and a respective receiving member 10, having a slot and fixed to back or second layer 150A. Thus, protective system 1A may be initially installed in a deflated positioned and initially secured from shifting via positioning member 230A. Thereafter, a user may install attachment system 200A and inflate inflation system 100A. Alternatively, a user may install positioning member 230A initially, then inflate inflation system 100A, and using their hands engage receiving member 10 to secure system 1A in position before or during strap/buckle engagement.

As yet another alternative arrangement, it will be recognized (based on FIG. 1k), that strap members 210A may form a continuous strap through a floating sleeve member 10′ that engages respective buckle points 240, 240 fixed on an exterior surface of strengthening layer 120A, in slots 10A, 10A in floating sleeve member 10′. Floating sleeve member 10′ is movable relative to strap member 210A to allow easy positioning. Consequently, this adaptive design supports the concept that alternative types of attachment systems 200A may be employed without departing from the scope of the present invention. An additional benefit of this embodiment (as with the earlier embodiment) is that strapping 210A provides compressive force to inflation system 100A to ensure secure positioning without injury to a structural member (such as a window).

An additional form of alternative aid involves guide rollers 12, 12 (FIG. 1l) on an exterior of strengthening layer 120A allowing strap members 210A to be readily adjusted thereto. Thus, guide rollers 12 feature, as with the earlier floating sleeve 10′, mechanisms for easy installation and ready securing from a convenient user position. As a result, the present protective system 1A is readily available for use with a variety of adaptively configured securing systems.

Referring additionally now to FIG. 1i it shall be noted by those of skill in the consumer products markets that protective system 1A may be readily stored over a hanger in a closet when not in use to improve convenience and speed of use. Consequently, it will be recognized that a user may install and remove protective system 1A from the inside of a structure or framing system 300A for maximum convenience.

As noted within in FIGS. 1d and 1g, air guards or cushions 9 are positioned on back or second layer 150A proximate likely outer bounds of double hung system 310A so as to provide additional weather protection while not restricting movement or installation. For example, air guards or cushions 9 may be constructed from semi-rigid foam, expanded foam, rubber, or other suitable weather-guard type material that allows flexible use and extension/compression to enable installation, removal, and storage, while also helping to protect structural system 300A and also help securely position protective system 1A relative to double hung system 310A.

As a consequence of the above, it should be recognized that protective system 1A enables the elastic absorption of stress from rigid debris 6 impact to prevent window cracking, and also provides a flexible installation and removal process. Similarly, while the present protective system 1A provides a preference for an inflatable feature (to maximize protection) it will be recognized that the present protective system 1A, B, etc. may be adapted to operate with a flexible shield (without inflation) that is secured via the proposed attachment or securing systems 200A, B, etc. without departing from the scope herein. Consequently, the present system envisions operation without inflation either via design choice to remove the inflation capacity or via circumstance wherein an inflation system 100A, B, etc. is punctured or deflated in use, while still effecting a measure of structural protection.

Referring now to FIGS. 2a through 2e, a second protective system 1B is proposed wherein an inflation system 100B includes an attachment system 200B and a rigid panel system or shielding system 110B on an outward facing layer. The present protective system 1B is positioned relative to a structural system 300B, shown here as a double hung system 310B.

Attachment system 200B, includes an adaptively positioned array of strap members 210B joined by buckle members 220B for securing over the top and bottom of double hung system 310B as shown.

Here a rear or back layer 150B is joined to panel system member 110B by a series of securing strapping or sealing layers 130B, 130B′ as noted (FIG. 2d). Strap members 210B are secured by strapping or sealing layers 130B″, and where there is overlap also by sealing layer 130B′. In this manner, an inflatable system 110B is constructed, and one or more inflation systems 11, 11 are provided as above for pressurization during use.

Here, an inner baffle member 14 is foldably secured to respective rear or second layer 150B and panel system or shield member 110B to provide additional lateral support. It shall be recognized, that sealing members 15 are functionally effective to serve as a living hinge, allowing baffle 14 to fold flat against panel system member 110B for convenient installation and sliding through the casement window. Similarly, and while not shown, it shall be recognized that shield or panel system 110B may itself have a living hinge or be foldable in half so as to additionally ease installation

As above, a rear adhesion member 230B is provided on a receiving member 10 for initial installation ease and to aid resistance to displacement under the effects of wind buffeting. Additionally, air guards and cushions 9 are also positioned about an outer periphery for the reasons noted above.

As shall be recognized in each embodiment of the present invention, the shape of an inflation system is not limited to the hexagonal, rectilinear, ovoidal, round etc., geometries noted herein, but is instead only limited by the needed shape determined by the manufacturer and consuming public. Thus, one or more protective systems 1B, 1A . . . 1N (an infinite number) may be provided or joined together to address a consumer need.

One principal benefit of the present protective system 1B is the additional protection afforded by shield or panel system 110B, alone or in combination with optional inner baffle member 14. In use, shield 110B resists debris and remains elastically absorptive due to its backing by an inflated air chamber. Attaching and securing system 200B functions similarly to those other securing systems noted herein to securely position protective system 1B. Installation is readily achieved from the interior of double hung system 310B, as suggested earlier, by simply shifting individual windows to allow the unit to be initially secured via adhesion members 230B and thereafter for attachment securing system 200B to be positioned.

Referring now to FIG. 3a, an adaptive protective system 1C is positionable relative to a structural system 300C, noted as including a casement system 320A having at least one window that pivots for opening and closing. Protective system 1C incorporates an inflation system 100C having a front or first layer side 140C and a back or second layer side 150C.

An attachment securing system 200C incorporates respective strap members 210C having respective buckle members 220C as shown.

A panel system 110C is secured to an external portion of the outer front face of front layer 140A and comprises multiple sheets of rigid material (for example Lexan, laminate composite, or reinforced glass or metal) joined by living hinges 16, 16. Living hinges 16, 16 allow protective system to be folded and readily positioned from inside the structure through casement window systems 320 in an un-inflated manner, and thereafter inflated and strapped and secured in position via attachment or securing system 200C. Obviously, an additional logo, warning, or other message may be positioned on panel system 110C as shown.

While not specifically noted herein, it is envisioned that strap members 210C may be secured to inflation system 100C and optionally to panel system 110C with strong and flexible adhesive, nylon stitching, thermal fusing, or in any other manner known to those in the art of preparing inflatable structures. Similar construction techniques are well known within those who manufacturer inflatable PVC water-craft and these maybe readily adapted to the attachment construction requirements within the embodiments discussed without departing from the scope of the present disclosure.

Referring now to FIG. 4a, an adaptive protective system 1D is positioned relative to an optional structural or frame system 300D, noted here as a double-window, double-hung system 310D. Based on this configuration, a manufacturer may readily adapt the present system, for example the system noted in FIGS. 1a-1l, to cover two windows at a time.

Here, an inflation system 100D, includes at least a front layer and rear layer 140D, 150D respectively and similarly includes a side strap member 130D, joined to a panelized rigid system 110D. Here, due to the width involved, a living hinge 16 joins two individual sheets of shielding (for example a hinge constructed from adhered PVC layers). Consequently, protective system 1D may be readily folded for storage and initial positioning and unfolded for installation and use without detracting from the scope of the present invention.

An attachment or securing system 200D includes adjustable strap members 210D and a series of buckles 220D. Thus, in a manner discussed earlier, adaptive protective system 1D may be readily installed, inflated, and secured in position to provide protection to framing system 300D and the attendant structure.

Referring now to FIGS. 5a and 5b, an adaptive protective system 1E includes an inflatable system 100E in adaptive combination with a shielding member 110E′. As noted in the figures, a fixed frame system 300E includes a double hung system 301E in combination with a fixed-immobile window 340E.

As a consequence, and in a manner similar to the earlier protective system the present invention is readily adapted to alternative construction and window styles by selective incorporation.

Hear inflation system 100E incorporates a front or first layer 140E joining a rear layer (not shown), and an optional shielding panel system 110E having a living hinge 16 is secured there two in a manner earlier discussed. Attachment securing system 200E includes a plurality of strap members 210E and buckle members 220E allowing secure positioning as earlier noted.

Due to the inclusion of a non-operational window member 340E, protective system 1E includes a joinable and separate protective shield 110E′ having one or more strap joining features 20 for operatively engaging straps 210E.

A front face of shield member 110E′ includes a pair of use handles 7, 7, so as to allow a user to readily position the shield while reaching from below via an open window 301E, or optionally handles 7 may be constructed in a form that engages the end of a ground-extension pole thereby enabling a ground-based user to fix shield 110E′ to the pole end and thereafter secure suction adhesion members 230E, engaged with receiving members 10 on shield 11E′ to the window.

As a consequence, those of skill in the art will readily appreciate, that the inventive protective system discussed herein may be easily adapted to a plurality of dwelling and commercial structures without departing from the scope of the discussion.

Referring now to FIG. 6a, an adaptive protective system 1F is provided for covering a sliding glass door 330F installed in framing or structural system 300F. Here, while slide straps may be readily positioned in a way disclosed in FIG. 3a (via the use of straps slid through the edges of the sliding doors) additional securing rollers 2 are affixable at anchor points (not shown) so as to receive straps 210F of an attachment or securing system 200F.

Buckle members 220F join respective ends of strap members 210F and slidably adjust to tension protective system in place. As noted earlier, straps 210F may be provided on the opposing door-sides (here the left and right sides) so as to be slid within the door openings much like a double hung window on its side (FIG. 1a, or like pivot opening casement windows (FIG. 3a). Each of these adaptations is readily supported by the above disclosure.

As noted a front or first flexible layer 140F of an inflation system 100F, optionally secures a series of flexibly joined rigid shielding panels 110F joined here by living hinges 16. It is recognized that shielding panels 110F may be removable from inflation system 100A for separate storage in a folded condition.

Referring now to FIGS. 7a, 7b, an adaptive protective system 1G is provided for covering an oval window retained within an oval structural or framing system 300G. Here, the oval window is not openable, as in early solutions but includes a rather deep casement. An inflation system 100G includes an inflation valve (not shown), and front and back flexible layers 140G, 150G joined in a manner noted earlier. A rigid shielding member 110G is removably positionable on an exterior surface of front layer 100G as noted, and a rear or back fixing panel 8 is secured to rear layer 150G, as noted.

One or more adhesion members 230G are removably positioned on panel 8 thereby allowing a user to inflate protective system 1G and secure the system in position by affixing the adhesion members to the window glass itself.

Alternative embodiments are envisioned wherein, inflation system 100G is removable from panel 8, allowing a user to initially position panel 8, test its secure position, and then employing a removable system (such as Velcro) on cooperating faces of panel 8 and rear layer 150G, removably affix inflation system 100G onto the window. It will be recognized that each inflation system may be readily adapted by shape and construction methods to alternatively shaped windows and structures, so as to prove a secure protection.

Referring now to FIGS. 8a, 8b, and 8c, an adaptive protective system 1H is provided for covering a garage door 330H fixed within a structural system or frame system 300H. Here, adaptive rollers 2 are secured within anchor points 3 each having respective anchor covers 3′ for use during periods of non-installation so as to allow a user access to a smooth garage entrance for a vehicle. Obviously, during use, covers 3′ are removed and rollers 2 are securely installed.

As noted, an inflation system 100H includes respective layers (not designated) joined to an attachment system 200H including respective straps members 210H and buckles 220H in a manner earlier discussed.

Again here, adaptive shielding members 110H may be additionally affixed (either permanently upon manufacture, or temporarily via Velcro or other fastenings) to provide additional protection. A series of live hinges 16 are proposed to allow ready folding of various shield or panels 110H relative to each other for simplified and compact storage following non-use.

Referring now to FIGS. 11a, 11b, and 11c, an adaptive protective system 1K is provided relative to a frame system 300K noted here as a double hung system 310K.

An inflation system 100K is provided with a front or first layer 140A, a rear layer 1150A, joined by a side strap or support member 130K. As can be seen particularly well in FIGS. 11b and 11c, inflation system 100K is formed in a tubular form having a generally open inner region, although inflation cross-members may be readily provided for additional inner support and protection.

An attachment or securing system 200K is provided including strap members 210K and buckle members 220K, as shown and as earlier discussed. Here, strap members 210K are fixed to regions on inflation system 100K but may be also formed as continuous loops as in the initial and earlier embodiments.

A safety mesh or flexible member 17 is positioned covering the inner region of inflation system 100K, as noted, and it shall be recognized that flexible member 17 may be constructed from any suitable material, including those noted above, as well as high-strength materials such as Kevlar, Spider-Wire, and other man-made high-strength fibers (used in protective garments, sporting equipment, and the safety industry).

A removable shield or panel system 110K is provided having a plurality of sub-members 110K′ joined by living hinges 16, as earlier noted, thereby allowing ready folding for storage while enhancing structural protection.

As suggested in this embodiment, the present invention recognizes inflation system may be used in various configurations to over the most advantageous protection to a circumstance. Here, inflation system 100K is readily stored in an un-inflated state, and serves as a supportive non-structurally-damaging boarder for shielding or panel system 110K, having only a flexible member 17 as a general shield. Consequently, even where a manufacturer selects the use of flexible member 17 (constructed from various materials along a range of strengths and toughness) an additional shielding system 110K may be adaptively incorporated without departing from the scope of the present invention.

Referring now to FIGS. 9a and 10a, respective frame systems 300I, 300J are covered by any of the earlier noted embodiments (protective systems) noted herein as protective systems 1H, 1J.

As will be noted, and as introduced with the earlier notations of “logo” or other notice, an adaptive cover 100I, 100J may be incorporated as an ornamental feature for seasonal or event celebration, shown here as holiday decorations. Consequently, it will be recognized, that the proposed adaptive protection systems 1A-1K may be readily adapted to a wide variety of uses, including protective and decorative uses.

It is additionally noted, specifically for those embodiments of the protective system adapted for doors, that additional features for anchoring or stabilizing may be included such as water-filled bases, anchor flaps for receiving sand-bags or weights, etc. without departing from the scope of the present invention.

Finally, it will be readily recognized that each protective system 1A, 1B, etc. may be readily adapted to provide longer-term or enhanced temporary protection to structures (windows/doors etc.), while retaining the ready removal and storage features between uses.

As used herein the phrases structural system or framing system shall be recognized to include but not be limited to door, window, and other access openings in commercial and residential structures that commonly require protection during storms but do not include walls, ceilings, floors, or roofs that lack structural openings.

As a last note, while the present discussion has been focused on the alternative adaptations of the present system, the instant invention additionally includes both a method for constructing the instant protective systems in adaptive embodiments, as well as a method for customizing the present protective system to a particular location. As a consequence, what is additionally discussed herein is a method wherein a manufacturer provides an agent to review a structures framing system and determine the particular dimensional requirements for shielding selected openings, windows, doors, etc., and for providing such dimensional requirements to a manufacturing system what will provide a protective system having sizes customized to a structures particular needs. For example, a home may have large circular windows or may have a plurality of casement and double hung window combinations. The present invention is readily adapted to each variable combination without departing from the scope of the invention.

Those of skill in the art will recognize that the use of the phrase “opening in a framing system” should be interpreted broadly to represent window, door, and other openings that would be suitable for relative protection according to the various aspects and embodiments of the present invention. For example, and without limitation thereto, a window in a wall, a sliding glass door, and a skylight would both be examples of openings in a framing system without departing from the scope and spirit of the present invention.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A protective system, for providing a temporary-use protection to an opening in a framing system of a structure, comprising:
an inflation system including a means for inflating said inflation system; and
an attachment system for removably securing said inflation system covering said opening in said framing system during a use, whereby said inflation system may be deflated and removed from said opening following said temporary-use protection.

2. A protective system, according to claim 1, further comprising:
at least one of a strap member and an adhesion member in said attachment system.

3. A protective system, according to claim 2, wherein:
said attachment system includes at least said strap member; and
said at least one strap member including at least one buckle member for securing said strap member relative to said framing system.

4. A protective system, according to claim 2, wherein:
said attachment system includes said adhesion member; and
said adhesion member is at least one of a suction-cup member, a Velcro member, and a chemical adhesive member, whereby said attachment system may be removably secured to a said framing system.

5. A protective system, according to claim 1, wherein:
said means for inflating said inflation system includes at least one of means for inflation prior to said temporary-use and means for deflation of said inflation system following said temporary-use.

6. A protective system, according to claim 5, further comprising:
at least one of a flexible strengthening layer and a rigid shielding system on an external surface of said inflation system, whereby said at least one provides an enhanced protection to said framing system.

7. A protective system, according to claim 5, further comprising:
at least one non-inflatable fixably removable shield member, wherein said protective system may be readily adapted to alternative framing systems of a structure.

8. A protective kit, for providing temporary protection to an opening in a framing system of a structure comprising:
inflatable means for providing a repositionably secured temporary barrier to said opening in said framing system; and
attachment means for removably securing said inflatable means for providing relative to said opening in said framing system, thereby enabling a temporary-use protection of said protective kit to protect said opening.

9. A protective kit, according to claim 8, further comprising:
a decorative member;
said decorative member affixed to an outer covering of said inflatable means for providing, whereby said protective kit is readily adapted to a decorative display.

10. A protective kit, according to claim 9, wherein:
said inflatable means for providing includes at least a first inflation chamber and an inflation access portal; and
said inflation access portal providing a resealable-use inflating access to said inflatable means during said temporary-use, whereby said inflatable means receives an inflating pressurizing medium and retains the same during said temporary use.

11. A protective kit, according to claim 8, wherein:
said attachment means includes at least one attachment member selected from a group comprising: a strap member, a suction-cup member, an adjustable length strap member, and a ballast member.

12. A protective kit, according to claim 8, wherein:
said inflatable means further comprises:
at least one of a rigid member, a non-rigid inflatable member, a wind-diverter member, a flexible assembly of rigid members, an inflatable perimeter support member, a combination of a rigid member and an inflatable member, an outer abrasion resistance layer member, and an internal strengthening baffle.

13. A protective kit, according to claim 11, wherein:
said attachment means includes at least one attachment member selected from a group comprising: a strap member, a suction-cup member, an adjustable length strap member, and a ballast member.

14. A protective kit, according to claim 13, wherein:
said inflatable means includes at least one rigid member; and
said attachment means includes at least said strap member, whereby said protective kit enables a protective shielding for said openings in said framing systems during said temporary-use.

15. A protective kit, according to claim 13, wherein:
said inflatable means includes at least one non-rigid inflatable member; and
said attachment means includes at least said suction-cup member, whereby said protective kit enables protection of said opening in a simplified and readily attached and removed manner.

16. A protective kit, according to claim 13, wherein:
said attachment means includes at least said adjustable length strap member;
said inflatable means includes said non-rigid inflatable member;
said non-rigid inflatable member forming a continuous bounded loop about a perimeter region of said opening in said framing system; and
said inflatable means further comprising:
at least one said rigid member affixed to said inflatable means, whereby during said temporary-use, said continuous bounded loop of said inflatable member provides a support of said at least one rigid member, thereby spacing said rigid member from said opening and enhancing a protection of said opening.

17. A method for manufacturing a temporary protective system for a framing system, comprising the steps of:
measuring a dimensional system for a framing system requiring said temporary protective system;
providing an inflatable means for providing a temporary barrier to said framing system; and
providing at least one attachment means for removably securing said inflatable means to said framing system, whereby said temporary protective system is manufactured.
